(19) United States
(12) Patent Application Publication
(10) Pub. No.: US 2013/0001886 A1
(43) Pub. Date: Jan. 3, 2013

(54) TWIST PROOF FLEXURES OF SEAL ASSEMBLIES

(75) Inventors: Binayak Roy, Guilderland, NY (US); Hrishikesh Vishvas Deo, Saratoga Springs, NY (US); Xiaoqing Zheng, Niskayuna, NY (US)

(73) Assignee: GENERAL ELECTRIC COMPANY, SCHENECTADY, NY (US)

(21) Appl. No.: 13/174,211

(22) Filed: Jun. 30, 2011

(51) Int. Cl. F16J 15/46; B23P 11/00

(52) U.S. Cl. 277/543; 29/888.3

(57) ABSTRACT

A seal assembly for a turbomachine is provided. The seal assembly includes multiple arcuate packing ring segments disposed intermediate to a stationary housing and a rotatable element about an axis. The seal assembly further includes multiple flexures mechanically coupled to the stationary housing and the multiple arcuate packing ring segments, wherein the multiple flexures are attached to the stationary housing and the arcuate packing ring segments at positions predetermined to control packing ring twist under differential pressure conditions.

### CROSS REFERENCE TO RELATED APPLICATIONS

This application is related to commonly assigned U.S. patent application Ser. No. 12/957,127, entitled “Method And Apparatus For Packing Rings,” filed 30 Nov. 2010, which is herein incorporated by reference.

### BACKGROUND

The invention relates generally to seals for reducing leakage of turbomachinery and more particularly to sealing assemblies supported on flexures with zero-twist design features.

Seals are typically utilized with turbomachinery such as gas turbines, steam turbines, aircraft engines, compressors, and other turbomachinery systems to impede flow leakages of a medium between rotating and stationary components from a high pressure region to a low pressure region. As one example, labyrinth seals are formed of a sealing surface on one component and restrictive ring on the other component which projects into close proximity with the sealing surface. A plurality of restrictive rings are commonly disposed in series to form alternating flow throttling and expanding regions along the labyrinth seal to reduce the pressure of the leakage medium through the dissipation of kinetic energy. In one more specific type of seal, a clearance of each tooth decreases progressively going from an upstream side of the turbomachinery to a downstream side of the turbomachinery. The progressive decrease in the clearances of the teeth creates a passive feedback in the hydrostatic forces generated by differential pressure across the seal assembly such that, as a tip clearance decreases, outward radial forces cause the packing ring to move away from the rotor and, as the tip clearance increases, inward radial forces cause the packing ring to move toward the rotor. This is known as the self-correcting behavior. However, deflections of the labyrinth seals may occur when the rotary machine passes through critical speeds and result in nullifying the effect of the progressive clearance of the seals and in eliminating the desirable “self-correcting” passive feedback.

Accordingly, it would be desirable to reduce leakages between the seal assembly and the rotating component of the rotary machine.

### BRIEF DESCRIPTION

In accordance with an embodiment of the invention, a seal assembly for a turbomachine is provided. The seal assembly includes multiple arcuate packing ring segments disposed intermediate to a rotatable element and a stationary housing. The seal assembly also includes multiple flexures mechanically coupled to the stationary housing and the plurality of arcuate packing ring segments. The multiple flexures are attached to the stationary housing and the arcuate packing ring segments at positions predetermined to control packing ring twist under differential pressure conditions.

In accordance with an embodiment of the invention, a method of manufacturing a seal assembly between a stationary housing of a turbomachine and a rotatable element for turning about an axis of the turbomachine is provided. The method includes disposing a circumferentially-segmented packing ring intermediate to the stationary housing and the rotatable element. The method also includes coupling a plurality of flexures to the stationary housing and the plurality of arcuate packing ring segments at positions relative to a line of action of effective axial force acting on the seal assembly for reducing packing ring twist under differential pressure conditions.

In accordance with an embodiment of the invention, a method of forming a gas path seal between a stationary housing of a turbomachine and a rotatable element for turning about an axis of the turbomachine is provided. The method includes disposing at least one arcuate plate on the inner surface of the stationary housing in a radial plane. The method also includes disposing a circumferentially-segmented packing ring intermediate to the arcuate plate and the rotatable element, wherein the packing ring comprises a plurality of arcuate teeth intermediate to the packing ring and the rotatable element. The clearances between the teeth and the rotatable element are variable from an upstream side of the turbomachine to a downstream side of the turbomachine. The method further includes coupling multiple flexures to the stationary housing and the plurality of arcuate packing ring segments, wherein the plurality of flexures are selectively positioned relative to each other to control packing ring twist under differential pressure conditions and attached to the stationary housing and the arcuate packing ring segments at positions to control packing ring twist under differential pressure conditions.

### DRAWINGS

These and other features, aspects, and advantages of the present invention will become better understood when the following detailed description is read with reference to the accompanying drawings in which like characters represent like parts throughout the drawings, wherein:

FIG. 1 is cross-sectional view of a turbomachine in accordance with an embodiment of the present invention.

FIG. 2 is a cross-sectional view of a turbine section of the turbomachine in accordance with an embodiment of the present invention.

FIG. 3 is a perspective view of a packing ring segment of a seal assembly of the turbomachine in accordance with an embodiment of the present invention.

FIG. 4 is flow chart of a method of manufacturing a seal assembly located between a stationary housing of a turbomachine and a rotating element in accordance with an embodiment of the present invention.

FIG. 5 is flow chart of a method of forming a gas path seal between a stationary housing of a turbomachine and a rotating element in accordance with an embodiment of the present invention.

### DETAILED DESCRIPTION

When introducing elements of various embodiments of the present invention, the articles “a,” “an,” “the,” and “said” are intended to mean that there are one or more of the elements. The terms “comprising,” “including,” and “having” are intended to be inclusive and mean that there may be additional elements other than the listed elements. Any examples of operating parameters are not exclusive of other parameters of the disclosed embodiments.

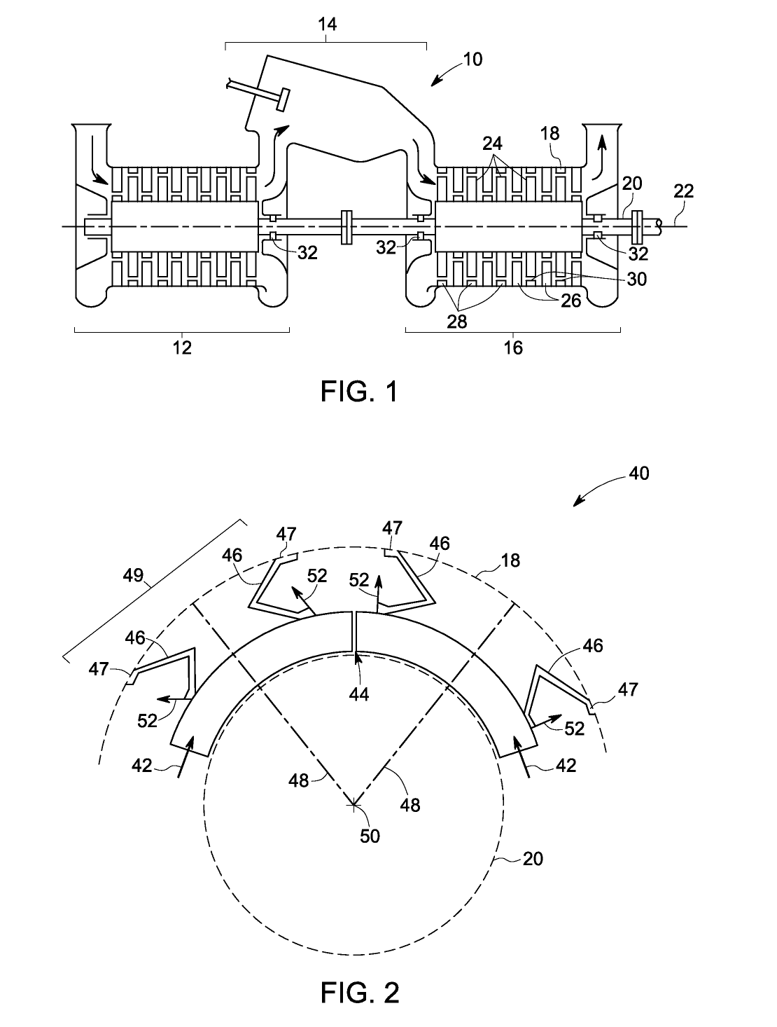

FIG. 1 is a cross-sectional view of an embodiment of a turbomachine 10, which may include a variety of components, some of which are not shown for the sake of simplicity. In the illustrated embodiment, the turbomachine 10 includes a compressor section 12, a combustor section 14, and a turbine section 16. The turbine section 16 includes a stationary housing 18 and a rotatable element 20, which rotates about an axis 22. Moving blades 24 are attached to the rotatable element 20 and stationary blades 26 are attached to the stationary housing 18. The moving blades 24 and stationary blades 26 are arranged alternately in the axial direction. There are several possible locations where seal assemblies may be installed, such as location 28 between a shrouded moving blade 24 and stationary housing 18, location 30 between the rotatable element 20 and stationary blade 26, or an end-packing sealing location 32 between rotatable element 20 and stationary housing 18.

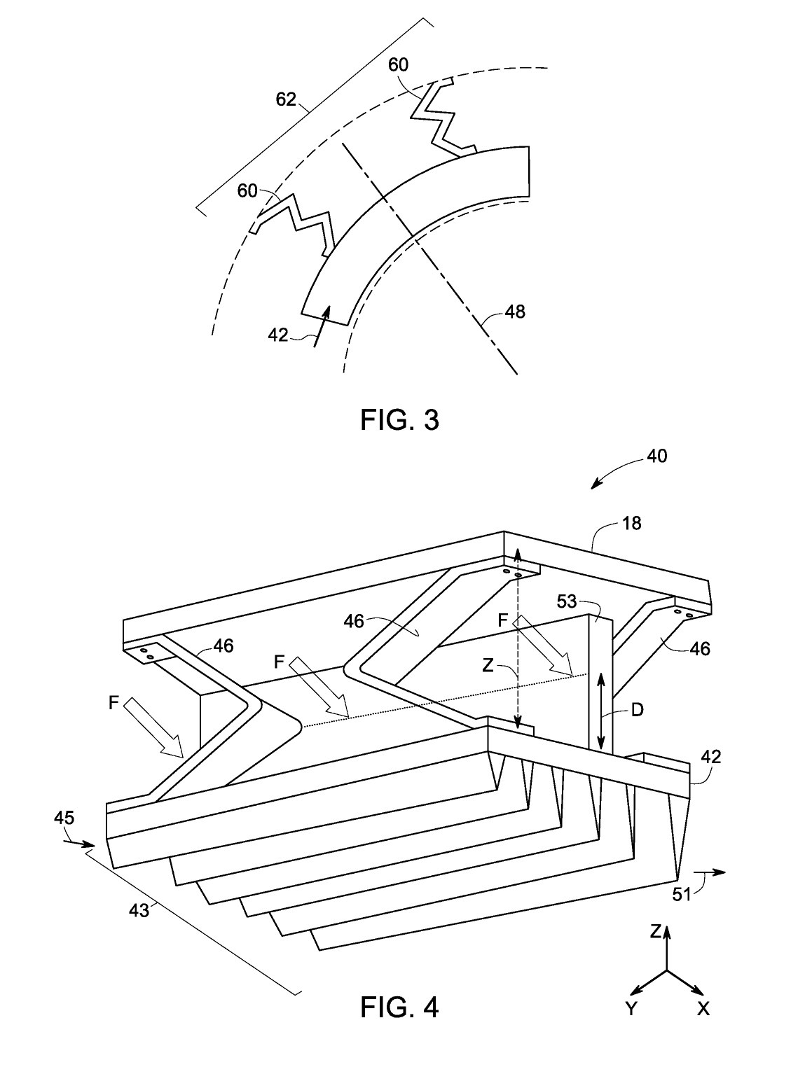

FIG. 2 is a partial cross-sectional view of a seal assembly 40 in a turbine section 16 of the turbomachine 10 in accordance with an embodiment of the present invention. As shown, the seal assembly 40 includes multiple arcuate packing ring segments 42 with inter-segments gaps 44 and disposed intermediate to the rotatable element 20 and stationary housing 18. In one embodiment, the seal assembly 40 includes multiple biasing members or flexures 46 that are mechanically coupled to the stationary housing 18 and the arcuate packing ring segments 42. The multiple flexures 46 limit motion of the arcuate packing ring segments 42 in the axial direction and allow motion of the arcuate packing ring segments in the radial direction 52. The multiple flexures 46 are attached to the stationary housing 18 and the arcuate packing ring segments 42 at positions predetermined to control packing ring twist due to axial forces acting on the packing ring due to the differential pressure in the turbine section 16. In one embodiment, a pair 49 of V-shaped flexures 46 at ends 47 that are symmetrically coupled to the stationary housing 18 and the arcuate packing ring segments 42 about a bisecting axis (or bisecting line) 48. The bisecting axis 48 bisects the arcuate packing ring segments 42, and the V-shaped flexures 46 are located approximately the same distance from the bisecting axis 48. The V-shape of the V-shaped flexures 46 is apparent when viewed along an axial axis 50. Because of the symmetric arrangement of the V-shaped flexures 46 about the bisecting axis 48, the arcuate packing ring segments 42 move substantially in the radial direction as indicated by the arrows 52. In other embodiments, more than one pair of V-shaped flexures 46 may be coupled to each of the arcuate packing ring segments 42 and may be symmetric with respect to the bisecting axis 48. Further, in other embodiments, the flexures may have different shapes. One example of such a shape is a W-shape flexure 60 as shown in the arcuate partial cross-sectional view of packing ring segment 42 in FIG. 3.

As shown in FIG. 3, a pair 62 of W-shaped flexures 60 is symmetrically coupled to the stationary housing 18 and the arcuate packing ring segments 42 about a bisecting axis 48.

FIG. 4 shows a perspective view of a packing ring segment 42 of the seal assembly 40 in accordance with an embodiment of the invention. In FIG. 4, for purposes of example, the packing ring is shown as a straight segment instead of an arcuate segment. The radius of curvature is set to infinity for ease of representation, but the concepts explained are the same for straight segment or arcuate/curved segment. As shown, the seal assembly 40 is a progressive clearance labyrinth seal that includes multiple arcuate teeth 43 disposed intermediate to the arcuate packing ring segments 42 and the rotatable element of turbomachine, forming a clearance therebetween. The clearance of each tooth 43 decreases progressively, in one embodiment, going from an upstream side 45 of the turbomachinery to a downstream side 51 of the turbomachine. As shown, two pair of the flexures 46 are disposed on opposite sides of a vertical plate section 53 of the packing ring segment 42. Based on a relative position D of a line of action of the effective axial force F acting on the vertical plate section 53 of the seal assembly 40 as shown, the multiple flexures 46 are attached to the packing ring segment 42 and the stationary housing 18 at predetermined position Z to control packing ring twist. The position Z is the relative distance of the attachment point of the flexures 46 on the stationary housing 18 from the packing ring segment 42 in the z-direction of a xyz coordinate system. Thus, the predetermined position Z vary relative to the position D of the line of action of the effective axial force F, acting on the vertical plate section 53 of the packing ring segment 42. This determination of the attachment points of the flexures ensures zero or near zero twist of the packing ring segment and thereby, maintains the progressive clearance of the seal assembly 40. Upon application of differential pressure, the packing ring is subject to a resultant axial force and a resultant radial force with associated lines of action of the force. The resultant radial force is balanced at the equilibrium due to the self-correcting behavior. The twist behavior of the packing ring depends on the distance “Z” of the flexure attachment. The resultant forces could result in positive twist, zero twist or negative twist. The positive twist can cause enhanced clearance progression of the labyrinth seals and results in higher fluidic stiffness. Whereas, negative twist causes elimination of the clearance progression and leads to zero feedback. Twist caused by the resultant forces should ideally be zero. However, in one embodiment it may be beneficial to design a small positive twist in some specifications to provide tolerance for manufacturing or assembly variations. The positive twist may also cause enhanced clearance progression of the seal assembly and thereby leading to higher fluidic stiffness.

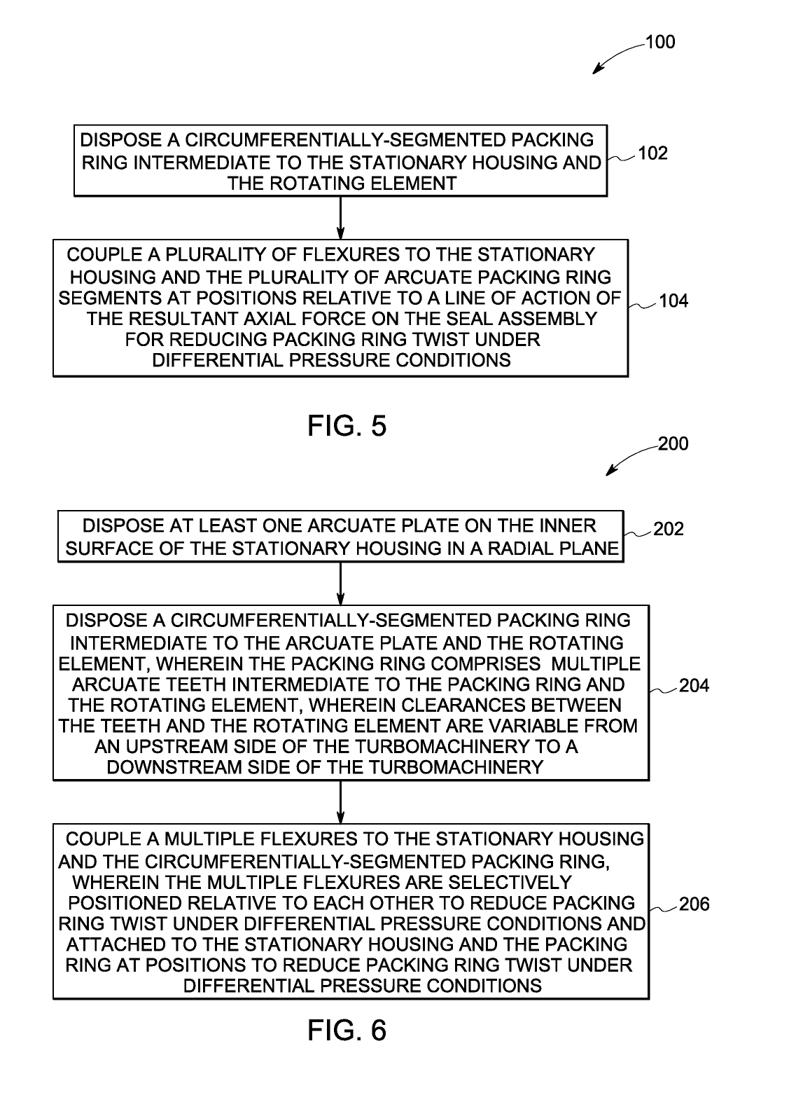

FIG. 5 shows a flow chart of a method 100 of manufacturing a seal assembly located between a stationary housing of a turbomachine and a rotatable element in accordance with an embodiment of the present invention. At step 102, the method includes disposing multiple arcuate packing ring segments intermediate to the stationary housing and the rotatable element. At step 104, the method includes coupling multiple flexures to the stationary housing and the multiple arcuate packing ring segments at positions relative to a line of action of force expected to axially impact the seal assembly for reducing packing ring twist under differential pressure conditions. The method further includes coupling the plurality of flexures to the stationary housing and the arcuate packing ring segments at positions predetermined based on a relative position of a line of action of effective force acting axially on the seal assembly for attaining a zero twist of the arcuate packing ring segments or a positive twist of the arcuate packing ring segment. At least some of the flexures are V-shaped or W-shaped when viewed axially along the axis of the turbomachine.

FIG. 6 is flow chart of a method 200 of forming a gas path seal between a stationary housing of a turbomachine and a rotatable element turning about an axis of the turbomachine in accordance with an embodiment of the present invention. In this embodiment, the method includes disposing at least one arcuate plate on the inner surface of the stationary housing in a radial plane at step 202. At step 204, the method further includes disposing a circumferentially-segmented packing ring intermediate to the arcuate plate and the rotatable element, wherein the packing ring comprises a plurality of arcuate teeth intermediate to the packing ring and the rotatable element, wherein clearances between the teeth and the rotatable element are variable from an upstream side of the turbomachinery to a downstream side of the turbomachinery. Further, at step 206, the method includes coupling a plurality of flexures to the stationary housing and the circumferentially-segmented packing ring, wherein the plurality of flexures are attached to the stationary housing and the packing ring at positions predetermined to control packing ring twist under differential pressure conditions. The method further includes attaching the plurality of flexures to the stationary housing and the packing ring at positions predetermined based on a relative position of a line of action of effective force acting axially on the packing ring for attaining a zero twist of the packing ring or attaining a positive twist of the packing ring.

Advantageously, the present invention enables reduced leakages by preventing distortion or twist of the progressive clearance labyrinth seals in the turbomachine under high differential pressures. This ensures that the desired clearance progression from the upstream side to the downstream side is maintained and the desired self-correcting behavior is maintained. The self-correcting behavior allows non-contact operation and allows a small tip-clearance between the rotatable element and the seal assembly leading to reduced leakages. This improves the efficiency and output of the rotary machine, and provides for a non-degrading performance of the machine.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

While only certain features of the invention have been illustrated and described herein, many modifications and changes will occur to those skilled in the art. It is, therefore, to be understood that the appended claims are intended to cover all such modifications and changes as fall within the true spirit of the invention.

1. A seal assembly for a turbomachine, the turbomachine comprising a stationary housing and a rotatable element about an axis, the seal assembly comprising:
a plurality of arcuate packing ring segments disposed intermediate to the rotatable element and the stationary housing; and
a plurality of flexures mechanically coupled to the stationary housing and the plurality of arcuate packing ring segments,
wherein the plurality of flexures are attached to the stationary housing and the arcuate packing ring segments at positions predetermined to control packing ring twist under differential pressure conditions.

2. The seal assembly of claim 1, wherein the plurality of flexures are attached to the stationary housing and the arcuate packing ring segments at positions predetermined based on a relative position of a line of action of effective force acting axially on the seal assembly for attaining a zero twist of the arcuate packing ring segments.

3. The seal assembly of claim 1, wherein the plurality of flexures are attached to the stationary housing and the arcuate packing ring segments at positions predetermined based on a relative position of a line of action of effective force acting axially on the seal assembly for attaining a positive twist of the arcuate packing ring segments.

4. The seal assembly of claim 1, wherein at least some of the flexures are V-shaped when viewed axially along the axis.

5. The seal assembly of claim 1, wherein at least some of the flexures are W-shaped when viewed axially along the axis.

6. The seal assembly of claim 1, wherein the plurality of flexures limits motion of the arcuate packing ring segments in an axial direction and allows motion of the arcuate packing ring segments in a radial direction.

7. The seal assembly of claim 1, wherein the seal assembly comprises a plurality of arcuate teeth disposed intermediate to the arcuate packing ring segments and the rotatable element, wherein a clearance of each tooth decreases progressively going from an upstream side of the turbomachinery to a downstream side of the turbomachinery.

8. A method of manufacturing a seal assembly between a stationary housing of a turbomachine and a rotatable element for turning about an axis of the turbomachine, the method comprising:
disposing a plurality of arcuate packing ring segments intermediate to the stationary housing and the rotatable element; and
coupling a plurality of flexures to the stationary housing and the plurality of arcuate packing ring segments at positions relative to a line of action of effective force expected to axially impact the seal assembly for controlling packing ring twist under differential pressure conditions.

9. The method of manufacturing of claim 8, further comprising coupling the plurality of flexures to the stationary housing and the arcuate packing ring segments at positions predetermined based on a relative position of a line of action of effective force acting axially on the seal assembly for attaining a zero twist of the arcuate packing ring segments.

10. The method of manufacturing of claim 8, further comprising coupling the plurality of flexures to the stationary housing and the arcuate packing ring segments at positions predetermined based on a relative position of a line of action of effective force acting axially on the seal assembly for attaining a positive twist of the arcuate packing ring segment.

11. The method of manufacturing of claim 8, wherein at least some of the plurality of flexures are V-shaped or W-shaped when viewed axially along the axis.

12. The method of manufacturing of claim 8, wherein the seal assembly comprises a plurality of arcuate teeth disposed intermediate to the arcuate packing ring segments and the rotatable element, wherein a clearance of each tooth decreases progressively going from an upstream side of the turbomachinery to a downstream side of the turbomachinery.

13. A method of forming a gas path seal between a stationary housing of a turbomachine and a rotatable element turning about an axis of the turbomachine, the method comprising:
disposing at least one arcuate plate on the inner surface of the stationary housing in a radial plane;
disposing a circumferentially-segmented packing ring intermediate to the arcuate plate and the rotatable element, wherein the packing ring comprises a plurality of arcuate teeth intermediate to the packing ring and the rotatable element, wherein clearances between the teeth and the rotatable element are variable from an upstream side of the turbomachinery to a downstream side of the turbomachinery; and
coupling a plurality of flexures to the stationary housing and the circumferentially-segmented packing ring, wherein the plurality of flexures are attached to the stationary housing and the packing ring at positions predetermined to control packing ring twist under differential pressure conditions.

14. The method of claim 13, further comprising attaching the plurality of flexures to the stationary housing and the packing ring at positions predetermined based on a relative position of a line of action of effective force acting axially on a vertical plate of the packing ring for attaining a zero twist of the packing ring.

15. The method of claim 14, further comprising attaching the plurality of flexures to the stationary housing and the packing ring at positions predetermined based on a relative position of a line of action of effective force acting axially on the vertical plate of the packing ring for attaining a positive twist for enhancing clearance progression.
